(19) United States
(12) Patent Application Publication
(10) Pub. No.: US 2021/0383417 A1
(43) Pub. Date: Dec. 9, 2021

(54) Article Transaction Management System, and Communication Terminal

(71) Applicants: Shinichi ASHIDA, Kamakura-shi, Kanagawa (JP); Hitoshi WATABE, Kamakura-shi, Kanagawa (JP)

(72) Inventors: Shinichi ASHIDA, Kamakura-shi, Kanagawa (JP); Hitoshi WATABE, Kamakura-shi, Kanagawa (JP)

(21) Appl. No.: 17/050,508

(22) PCT Filed: Jun. 7, 2020
(86) PCT No.: PCT/JP2020/022451

§ 371 Date: Oct. 26, 2020

(51) Int. Cl. G06Q 30/02

(52) U.S. Cl. CPC G06Q 30/0206

(57) ABSTRACT

A tobacco product transaction management system suitable to manage transactions of tobacco products is provided. A tobacco product transaction management server receives identification information of a cigarette and a user ID of a transactor of the cigarette from a mobile terminal, and registers, in a distributed ledger recorder, a transaction history related to a transferor user and transferee user of the cigarette and associated with the received identification information, the transaction history including the received identification information and user ID. Moreover, a server receives identification information from the mobile terminal, acquires a transaction history associated with the received identification information from the distributed ledger recorder, and calculates the value of the cigarette on the basis of the acquired transaction history. The value of the cigarette is displayed on the mobile terminal.

### TECHNICAL FIELD

The present invention relates to a technology for managing transactions of tobacco products. The present invention particularly relates to a tobacco product transaction management system, a transactor terminal, a transferor terminal, a transferee terminal, a transaction management apparatus, and a tobacco product or a container thereof, a tobacco product transaction management program, a transactor terminal program, a transferor terminal program, a transferee terminal program, a transaction management apparatus program, and a tobacco product or tobacco product container program, and a tobacco product production method, which are suitable to manage transactions of tobacco products.

### BACKGROUND ART

In a technology described in Patent Literature 1, a cigarette including individual cigarette identification information for identifying the cigarette, personal information of a purchaser of the cigarette, and the individual cigarette identification information are associated and registered in an individual cigarette information manager. Consequently, the purchaser of the cigarette is identified. When the purchaser disposes of the cigarette, the purchaser is identified on the basis of the individual cigarette identification information.

A technology described in Patent Literature 2 includes a server, a tobacco product vending machine, and a street ashtray. The server includes a sold item database that stores personally identifiable information for identifying a purchaser of a tobacco product, and stores article identification information for identifying a tobacco product, associated with the personally identifiable information. The tobacco product vending machine acquires personally identifiable information of a tobacco product purchaser, transmits the personally identifiable information, and article identification information of an article to be sold to the tobacco product purchaser identified from the personally identifiable information to the server via a network. The street ashtray reads article identification information of a discarded tobacco product, and transmits the article identification information to the server via the network. The server includes a checker that checks the article identification information transmitted from the street ashtray against the article identification information stored in the sold item database.

### CITATION LIST

### Patent Literature

Patent Literature 1: JP-A-2009-187432

Patent Literature 2: JP-A-2008-192121

### SUMMARY OF INVENTION

### Problems to be Solved by Invention

However, both of the technologies described in Patent Literatures 1 and 2 have a problem that when a purchaser of a tobacco product transfers the tobacco product to another person, and the transferee disposes of the tobacco product, then not the transferor but the purchaser is identified as the disposer. In other words, it is not possible to grasp who has transferred the tobacco product to whom.

Hence, the present invention has been made, focusing on such an unsolved problem of the known technologies. An object of the present invention is to provide a tobacco product transaction management system, a transactor terminal, a transferor terminal, a transferee terminal, a transaction management apparatus, and a tobacco product or a container thereof, a tobacco product transaction management program, a transactor terminal program, a transferor terminal program, a transferee terminal program, a transaction management apparatus program, and a tobacco product or tobacco product container program, and a tobacco product production method, which are suitable to manage transactions of tobacco products.

### Solutions to Problems

### First Aspect

In order to achieve the above object, a tobacco product transaction management system of a first aspect of the present invention includes: identification information etc. acquisition means for acquiring identification information recorded in a tobacco product or a container thereof, and transactor information related to a transactor of the tobacco product; and transaction history registration means for registering, in storage means, a transaction history related to a transferor and transferee of the tobacco product and associated with the identification information acquired by the identification information etc. acquisition means, the transaction history including the identification information and the transactor information acquired by the identification information etc. acquisition means.

Here, examples of the tobacco product include a cigarette, a cigar, a pipe, a Japanese pipe, a hookah, a smokeless tobacco product, a heat-not-burn tobacco product, and an electronic cigarette. The same shall apply to the following aspects of the present invention.

Moreover, the transactor, the transferor, and the transferee include a natural person and a juridical person. The transactor includes a transferor, a transferee, an intermediary, an agency, and other persons involved in a transaction of a tobacco product. The same shall apply to the following aspects of the present invention.

Moreover, the transactor information can be configured as, for example, information for identifying a transactor (for example, a name, number, ID, code, or link information such as a URL). Moreover, the transactor information can be configured as, for example, letters, a numeral, figure, code, symbol, image, audio, or other kinds of information. Moreover, the transactor information can be configured as a keyword related to a transactor (for example, one or more keywords representing a part of the name or designation of a transactor). The same shall apply to the following aspects of the present invention.

Moreover, for example, the identification information etc. acquisition means may input identification information, etc., from an input device or the like, retrieve or receive identification information, etc., from an external terminal or the like, read identification information, etc., from a storage device, storage medium, or the like, or generate or calculate identification information, etc., by information processing or the like. Therefore, acquisition includes at least input, retrieval, receipt, readout (including search), generation, and calculation. The concept of acquisition is the same below.

Moreover, the storage means stores a transaction history by every means and at every timing. The storage means may be configured in such a manner as a to previously store a transaction history, or store a transaction history on the basis of input or the like from the outside during operation of the system without previously recording the transaction history. The same shall apply to the following aspects of the present invention.

Moreover, the system may be realized as a single apparatus, terminal, or other devices. Alternatively, the system may be realized as a network system to which a plurality of apparatuses, terminals, and other devices is communicably connected to each other. In the latter case, each constituent element may belong to any of a plurality of devices or the like as long as it is communicably connected to each other. The same shall apply to the following aspects of the present invention.

### Second Aspect

Furthermore, the tobacco product transaction management system of a second aspect of the present invention according to the tobacco product transaction management system of the first aspect of the present invention includes: identification information acquisition means for acquiring the identification information; transaction history acquisition means for acquiring, from the storage means, the transaction history associated with the identification information acquired by the identification information acquisition means; and value calculation means for calculating the value of the tobacco product on the basis of the transaction history acquired by the transaction history acquisition means.

### Third Aspect

Furthermore, the tobacco product transaction management system of a third aspect of the present invention according to the tobacco product transaction management system of the first aspect of the present invention includes: identification information acquisition means for acquiring the identification information; transaction history acquisition means for acquiring, from the storage means, the transaction history associated with the identification information acquired by the identification information acquisition means; owner information acquisition means for acquiring owner information related to an owner of the tobacco product; and owner appropriateness determination means for determining the appropriateness of the owner of the tobacco product on the basis of the transaction history acquired by the transaction history acquisition means, and the owner information acquired by the owner information acquisition means.

Here, the owner information can be configured as, for example, information for identifying an owner (for example, a name, number, ID, code, or link information such as a URL). Moreover, the owner information can be configured as, for example, letters, a numeral, figure, code, symbol, image, audio, or other kinds of information. Moreover, the owner information can be configured as a keyword related to an owner (for example, one or more keywords representing a part of the name or designation of an owner). The same shall apply to the following aspects of the present invention.

### Fourth Aspect

Furthermore, the tobacco product transaction management system of a fourth aspect of the present invention according to the tobacco product transaction management system of the first aspect of the present invention includes: identification information acquisition means for acquiring the identification information; transaction history acquisition means for acquiring, from the storage means, the transaction history associated with the identification information acquired by the identification information acquisition means; and disposer identifying means for identifying a disposer of the tobacco product on the basis of the transaction history acquired by the transaction history acquisition means.

### Fifth Aspect

Further, a tobacco product transaction management system according to a fifth aspect of the present invention includes: identification information acquisition means for acquiring identification information; transaction history acquisition means for acquiring a transaction history associated with the identification information acquired by the identification information acquisition means from storage means for storing the transaction history related to a transferor and transferee of a tobacco product and associated with the identification information recorded in the tobacco product or a container thereof, the transaction history including the identification information and transactor information related to a transactor of the tobacco product; and value calculation means for calculating the value of the tobacco product on the basis of the transaction history acquired by the transaction history acquisition means.

### Sixth Aspect

Furthermore, a tobacco product transaction management system of a sixth aspect of the present invention includes: identification information acquisition means for acquiring identification information; transaction history acquisition means for acquiring a transaction history associated with the identification information acquired by the identification information acquisition means from storage means for storing the transaction history related to a transferor and transferee of a tobacco product and associated with the identification information recorded in the tobacco product or a container thereof, the transaction history including the identification information and transactor information related to a transactor of the tobacco product; owner information acquisition means for acquiring owner information related to an owner of the tobacco product; and owner appropriateness determination means for determining the appropriateness of the owner of the tobacco product on the basis of the transaction history acquired by the transaction history acquisition means, and the owner information acquired by the owner information acquisition means.

### Seventh Aspect

Furthermore, a tobacco product transaction management system of a seventh aspect of the present invention includes: identification information acquisition means for acquiring identification information; transaction history acquisition means for acquiring a transaction history associated with the identification information acquired by the identification information acquisition means from storage means for storing the transaction history related to a transferor and transferee of a tobacco product and associated with the identification information record in the tobacco product or a container thereof, the transaction history including the identification information and transactor information related to a transactor of the tobacco product; and disposer identifying means for identifying a disposer of the tobacco product on the basis of the transaction history acquired by the transaction history acquisition means.

### Eighth Aspect

Furthermore, in the tobacco product transaction management system of an eighth aspect of the present invention according to the tobacco product transaction management system of any of the first to seventh aspects of the present invention, the storage means is a distributed ledger.

### Ninth Aspect

Furthermore, in the tobacco product transaction management system of a ninth aspect of the present invention according to the tobacco product transaction management system of any of the first to eighth aspects of the present invention, the identification information is recorded in a part of the tobacco product housed in the container.

### Tenth Aspect

Furthermore, in the tobacco product transaction management system of a tenth aspect of the present invention according to the tobacco product transaction management system of any of the first to ninth aspects of the present invention, the identification information is recorded in a tobacco product selected by a predetermined rule from tobacco products to be shipped to the market.

### Eleventh Aspect

On the other hand, in order to achieve the above object, a transactor terminal of an eleventh aspect of the present invention is a transactor terminal applied to the tobacco product transaction management system of any of the first to fourth aspects of the present invention, and includes: identification information acquisition means for acquiring the identification information from the tobacco product or the container thereof; and identification information etc. output means for outputting the identification information acquired by the identification information acquisition means, and the transactor information related to the transactor of the tobacco product in such a manner as to be able to be acquired by the identification information etc. acquisition means.

### Twelfth Aspect

On the other hand, in order to achieve the above object, in the tobacco product transaction management system of a twelfth aspect of the present invention according to the tobacco product transaction management system of any of the first to fourth aspects of the present invention, a transferor terminal used by the transferor and a transferee terminal used by the transferee are communicably connected to each other, the transferor terminal includes approval means for approving transfer of the tobacco product, the transferee terminal includes: identification information acquisition means for acquiring the identification information from the tobacco product or the container thereof; and identification information etc. output means for outputting the identification information acquired by the identification information acquisition means and the transactor information where the transferee is the transactor in such a manner as to be able to be acquired by the identification information etc. acquisition means, and the transaction history is registered upon approval being gained from the transferor terminal.

### Thirteenth Aspect

Furthermore, in the tobacco product transaction management system of a thirteenth aspect of the present invention according to the tobacco product transaction management system of the twelfth aspect of the present invention, the identification information etc. output means outputs the identification information and the transactor information upon approval being gained from the transferor terminal.

### Fourteenth Aspect

Furthermore, in the tobacco product transaction management system of a fourteenth aspect of the present invention according to the tobacco product transaction management system of the twelfth aspect of the present invention, the transaction history registration means registers the transaction history upon approval being gained from the transferor terminal.

### Fifteenth Aspect

On the other hand, in order to achieve the above object, a transferor terminal of a fifteenth aspect of the present invention is a transferor terminal applied to the tobacco product transaction management system of any of the twelfth to fourteenth aspects of the present invention, and includes approval means for approving transfer of the tobacco product.

### Sixteenth Aspect

On the other hand, in order to achieve the above object, a transferee terminal of a sixteenth aspect of the present invention is a transferee terminal applied to the tobacco product transaction management system of any of the twelfth to fourteenth aspects of the present invention, and includes: identification information acquisition means for acquiring the identification information from the tobacco product or the container thereof; and identification information etc. output means for outputting the identification information acquired by the identification information acquisition means and the transactor information where the transferee is the transactor in such a manner as to be able to be acquired by the identification information etc. acquisition means.

### Seventeenth Aspect

On the other hand, in order to achieve the above object, a tobacco product or a container thereof of a seventeenth aspect of the present invention is a tobacco product or a container thereof applied to the tobacco product transaction management system of any of the first to fourth aspects of the present invention, and includes: transactor information acquisition means for acquiring the transactor information related to the transactor of the tobacco product; and identification information etc. output means for outputting the identification information of the tobacco product and the transactor information acquired by the transactor information acquisition means in such a manner as to be able to be acquired by the identification information etc. acquisition means.

### Eighteenth Aspect

On the other hand, in order to achieve the above object, a transaction management apparatus of an eighteenth aspect of the present invention is a transaction management apparatus applied to the tobacco product transaction management system of any of the first to fourth aspects of the present invention, and includes: identification information acquisition means for acquiring the identification information from the tobacco product or the container thereof; transactor information acquisition means for acquiring the transactor information related to the transactor of the tobacco product; and identification information etc. output means for outputting the identification information acquired by the identification information acquisition means and the transactor information acquired by the transactor information acquisition means in such a manner as to be able to be acquired by the identification information etc. acquisition means.

### Nineteenth Aspect

On the other hand, in order to achieve the above object, a tobacco product transaction management program of a nineteenth aspect of the present invention is a program for causing a computer to execute a process including: an identification information etc. acquisition step of acquiring identification information recorded in a tobacco product or a container, and transactor information related to a transactor of the tobacco product; and a transaction history registration step of registering, in storage means, a transaction history related to a transferor and transferee of the tobacco product and associated with the identification information acquired in the identification information etc. acquisition step, the transaction history including the identification information and the transactor information acquired in the identification information etc. acquisition step.

### Twentieth Aspect

A tobacco product transaction management program according to a twentieth aspect of the present invention is a program for causing a computer to execute a process including: an identification information acquisition step of acquiring identification information; a transaction history acquisition step of acquiring a transaction history associated with the identification information acquired in the identification information acquisition step from storage means for storing the transaction history related to a transferor and transferee of a tobacco product and associated with the identification information recorded in the tobacco product or a container thereof, the transaction history including the identification information and transactor information related to a transactor of the tobacco product; and a value calculation step of calculating the value of the tobacco product on the basis of the transaction history acquired in the transaction history acquisition step.

### Twenty-first Aspect

Furthermore, a tobacco product transaction management program of a twenty-first aspect of the present invention is a program for causing a computer to execute a process including: an identification information acquisition step of acquiring identification information; a transaction history acquisition step of acquiring a transaction history associated with the identification information acquired in the identification information acquisition step from storage means for storing the transaction history related to a transferor and transferee of a tobacco product and associated with the identification information recorded in the tobacco product or a container thereof, the transaction history including the identification information and transactor information related to a transactor of the tobacco product; an owner information acquisition step of acquiring owner information related to an owner of the tobacco product; and owner appropriateness determination step of determining the appropriateness of the owner of the tobacco product on the basis of the transaction history acquired in the transaction history acquisition step, and the owner information acquired in the owner information acquisition step.

### Twenty-Second Aspect

Furthermore, a tobacco product transaction management program of a twenty-second aspect of the present invention is a program for causing a computer to execute a process including: an identification information acquisition step of acquiring identification information; a transaction history acquisition step of acquiring a transaction history associated with the identification information acquired in the identification information acquisition step from storage means for storing the transaction history related to a transferor and transferee of a tobacco product and associated with the identification information recorded in the tobacco product or a container thereof, the transaction history including the identification information and transactor information related to a transactor of the tobacco product; and a disposer identifying step of identifying a disposer of the tobacco product on the basis of the transaction history acquired in the transaction history acquisition step.

### Twenty-Third Aspect

On the other hand, in order to achieve the above object, a transactor terminal program of a twenty-third aspect of the present invention is a program applied to the transactor terminal of the eleventh aspect of the present invention, and is a program for causing a computer to execute a process including: identification information acquisition step of acquiring the identification information from the tobacco product or the container thereof; and identification information etc. output step of outputting the identification information acquired in the identification information acquisition step, and the transactor information related to the transactor of the tobacco product in such a manner as to be able to be acquired in the identification information etc. acquisition step.

### Twenty-Fourth Aspect

On the other hand, in order to achieve the above object, a transferor terminal program of a twenty-fourth aspect of the present invention is a program applied to the transferor terminal of the fifteenth aspect of the present invention, and is a program for causing a computer to execute a process including an approval step of approving transfer of the tobacco product.

### Twenty-Fifth Aspect

On the other hand, in order to achieve the above object, a transferee terminal program of a twenty-fifth aspect of the present invention is a program applied to the transferee terminal of the sixteenth aspect of the present invention, and is a program for causing a computer to execute a process including: an identification information acquisition step of acquiring the identification information from the tobacco product or the container thereof; and identification information etc. output step of outputting the identification information acquired in the identification information acquisition step and the transactor information where the transferee is the transactor in such a manner as to be able to be acquired in the identification information etc. acquisition step.

### Twenty-Sixth Aspect

On the other hand, in order to achieve the above object, a tobacco product or tobacco product container program of a twenty-sixth aspect of the present invention is a program applied to the tobacco product or the container thereof of the seventeenth aspect of the present invention, and is a program for causing a computer to execute a process including: a transactor information acquisition step of acquiring the transactor information related to the transactor of the tobacco product; and an identification information etc. output step of outputting the identification information of the tobacco product, and the transaction information acquired in the transactor information acquisition step.

### Twenty-Seventh Aspect

On the other hand, in order to achieve the above object, a transaction management apparatus program of a twenty-seventh aspect of the present invention is a program applied to the transaction management apparatus of the eighteenth aspect of the present invention, and is a program for causing a computer to execute a process including: an identification information acquisition step of acquiring the identification information from the tobacco product or the container thereof; a transactor information acquisition step of acquiring the transactor information related to the transactor of the tobacco product; and an identification information etc. output step of outputting the identification information acquired in the identification information acquisition step and the transactor information acquired in the transactor information acquisition step in such a manner as to be able to be acquired in the identification information etc. acquisition step.

### Twenty-Eighth Aspect

On the other hand, in order to achieve the above object, a tobacco product production method of a twenty-eighth aspect of the present invention includes the step of recording the identification information used in the tobacco product transaction management system of any of the first to tenth aspects of the present invention in a part of the tobacco product housed in the container.

### Twenty-Ninth Aspect

Furthermore, a tobacco product production method of a twenty-ninth aspect of the present invention includes the step of recording the identification information used in the tobacco product transaction management system of any of the first to tenth aspects of the present invention in a tobacco product selected by a predetermined rule from tobacco products to be shipped to the market.

### Thirtieth Aspect

On the other hand, in order to achieve the above object, a tobacco product transaction management system of a thirtieth aspect of the present invention includes transaction history registration means for registering a transaction history including transactor information related to a transactor of a tobacco product in storage means included in the tobacco product or a container thereof.

### Thirty-First Aspect

Furthermore, a tobacco product transaction management system of a thirty-first aspect of the present invention includes: transaction history acquisition means for acquiring a transaction history including transactor information related to a transactor of a tobacco product from storage means included in the tobacco product or a container thereof, the storage means being for storing the transaction history; and value calculation means for calculating the value of the tobacco product on the basis of the transaction history acquired by the transaction history acquisition means.

### Thirty-Second Aspect

Furthermore, a tobacco product transaction management system of a thirty-second aspect of the present invention includes: transaction history acquisition means for acquiring a transaction history including transactor information related to a transactor of a tobacco product from storage means included in the tobacco product or a container thereof, the storage means being for storing the transaction history; owner information acquisition means for acquiring owner information related to an owner of the tobacco product; and owner appropriateness determination means for determining the appropriateness of the owner of the tobacco product on the basis of the transaction history acquired by the transaction history acquisition means, and the owner information acquired by the owner information acquisition means.

### Thirty-Third Aspect

Furthermore, a tobacco product transaction management system of a thirty-third aspect of the present invention includes: transaction history acquisition means for acquiring a transaction history including transactor information related to a transactor of a tobacco product from storage means included in the tobacco product or a container thereof, the storage means being for storing the transaction history; and disposer identifying means for identifying a disposer of the tobacco product on the basis of the transaction history acquired by the transaction history acquisition means.

### Thirty-Fourth Aspect

On the other hand, in order to achieve the above object, a tobacco product transaction management program of a thirty-fourth aspect of the present invention is a program for causing a computer to execute a process including a transaction history registration step of registering a transaction history including transactor information related to a transactor of a tobacco product in storage means included in the tobacco product or a container thereof.

### Thirty-Fifth Aspect

Furthermore, a tobacco product transaction management program of a thirty-fifth aspect of the present invention is a program for causing a computer to execute a process including: a transaction history acquisition step of acquiring a transaction history including transactor information related to a transactor of a tobacco product from storage means included in the tobacco product or a container thereof, the storage means being for storing the transaction history; and a value calculation step of calculating the value of the tobacco product on the basis of the transaction history acquired in the transaction history acquisition step.

### Thirty-Sixth Aspect

Furthermore, a tobacco product transaction management program of a thirty-sixth aspect of the present invention is a program for causing a computer to execute a process including: a transaction history acquisition step of acquiring a transaction history including transactor information related to a transactor of a tobacco product from storage means included in the tobacco product or a container thereof, the storage means being for storing the transaction history; an owner information acquisition step of acquiring owner information related to an owner of the tobacco product; and an owner appropriateness determination step of determining the appropriateness of the owner of the tobacco product on the basis of the transaction history acquired in the transaction history acquisition step, and the owner information acquired in the owner information acquisition step.

### Thirty-Seventh Aspect

Furthermore, a tobacco product transaction management program of a thirty-seventh aspect of the present invention is a program for causing a computer to execute a process including: a transaction history acquisition step of acquiring a transaction history including transactor information related to a transactor of a tobacco product from storage means included in the tobacco product or a container thereof, the storage means being for storing the transaction history; and a disposer identifying step of identifying a disposer of the tobacco product on the basis of the transaction history acquired in the transaction history acquisition step.

### Thirty-Eighth Aspect

On the other hand, in order to achieve the above object, a tobacco product or a container thereof of a thirty-eighth aspect of the present invention includes: storage means; transaction information acquisition means for acquiring transactor information related to a transactor of the tobacco product; and transaction history registration means for registering, in the storage means, a transaction history including the transactor information acquired by the transactor information acquisition means.

### Thirty-Ninth Aspect

On the other hand, in order to achieve the above object, a tobacco product transaction management system of a thirty-ninth aspect of the present invention is a tobacco product transaction management system applied to the tobacco product or the container thereof of the thirty-eighth aspect of the present invention, and includes: transaction history acquisition means for acquiring the transaction history from the storage means; and value calculation means for calculating the value of the tobacco product on the basis of the transaction history acquired by the transaction history acquisition means.

### Fortieth Aspect

Furthermore, a tobacco product transaction management system of a fortieth aspect of the present invention is a tobacco product transaction management system applied to the tobacco product or the container thereof of the thirty-eighth aspect of the present invention, and includes: transaction history acquisition means for acquiring the transaction history from the storage means; owner information acquisition means for acquiring owner information related to an owner of the tobacco product; and owner appropriateness determination means for determining the appropriateness of the owner of the tobacco product on the basis of the transaction history acquired by the transaction history acquisition means, and the owner information acquired by the owner information acquisition means.

### Forty-First Aspect

Furthermore, a tobacco product transaction management system of a forty-first aspect of the present invention is a tobacco product transaction management system applied to the tobacco product or the container thereof of the thirty-eighth aspect of the present invention, and includes: transaction history acquisition means for acquiring the transaction history from the storage means; and disposer identifying means for identifying a disposer of the tobacco product on the basis of the transaction history acquired by the transaction history acquisition means.

### Forty-Second Aspect

On the other hand, in order to achieve the above object, a tobacco product or a container thereof of a forty-second aspect of the present invention is a tobacco product transaction management program applied to a tobacco product or a container thereof having storage means, and is a program for causing a computer to execute a process including: a transactor information acquisition step of acquiring transactor information related to a transactor of the tobacco product; and a transaction history registration step of registering, in the storage means, a transaction history including the transactor information acquired in the transactor information acquisition step.

### Forty-Third Aspect

On the other hand, in order to achieve the above object, a tobacco product transaction management program of a forty-third aspect of the present invention is a tobacco product transaction management program applied to the tobacco product or the container thereof of the thirty-eighth aspect of the present invention, and is a program for causing a computer to execute a process including: a transaction history acquisition step of acquiring the transaction history from the storage means; and a value calculation step of calculating the value of the tobacco product on the basis of the transaction history acquired in the transaction history acquisition step.

### Forty-Fourth Aspect

Furthermore, a tobacco product transaction management program of a forty-fourth aspect of the present invention is a tobacco product transaction management program applied to the tobacco product or the container thereof of the thirty-eighth aspect of the present invention, and is a program for causing a computer to execute a process including: a transaction history acquisition step of acquiring the transaction history from the storage means; an owner information acquisition step of acquiring owner information related to an owner of the tobacco product; and an owner appropriateness determination step of determining the appropriateness of the owner of the tobacco product on the basis of the transaction history acquired in the transaction history acquisition step and the owner information acquired in the owner information acquisition step.

### Forty-Fifth Aspect

Furthermore, a tobacco product transaction management program of a forty-fifth aspect of the present invention is a tobacco product transaction management program applied to the tobacco product or the container thereof of the thirty-eighth aspect of the present invention, and is a program for causing a computer to execute a process including: a transaction history acquisition step of acquiring the transaction history from the storage means; and a disposer identifying step of identifying a disposer of the tobacco product on the basis of the transaction history acquired in the transaction history acquisition step.

### EFFECTS OF INVENTION

As described above, according to the tobacco product transaction management system of the first aspect of the present invention, it is possible to grasp a transaction history related to a transferor and transferee of a tobacco product.

Furthermore, according to the tobacco product transaction management system of the second, fifth, thirty-first, or thirty-ninth aspect of the present invention, or the tobacco product transaction management program of the twentieth, thirty-fifth, or forty-third aspect of the present invention, it is possible to grasp the value of the tobacco product on the basis of the transaction history.

Furthermore, according to the tobacco product transaction management system of the third, sixth, thirty-second, or fortieth aspect of the present invention, or the tobacco product transaction management system of the twenty-first, thirty-sixth, or forty-fourth aspect of the present invention, it is possible to grasp the appropriateness of an owner of the tobacco product.

Furthermore, according to the tobacco product transaction management system of the fourth, seventh, thirty-third, or forty-first aspect of the present invention, or the tobacco product transaction management program of the twenty-second, thirty-seventh-, or forty-fifth aspect of the present invention, it is possible to grasp a disposer of the tobacco product, for example, even if the tobacco product is transferred to another person after the purchase of the tobacco product.

Furthermore, according to the tobacco product transaction management system of the eighth aspect of the present invention, it is possible to reduce a possibility of, for example, tampering with the transaction history.

Furthermore, according to the tobacco product transaction management system of the ninth or tenth aspect of the present invention, or the tobacco product production method of the twenty-eighth or twenty-ninth aspect of the present invention, it is possible to selectively or partially conduct, for example, a sample survey.

### BRIEF DESCRIPTION OF DRAWINGS

FIG. 1 is a configuration diagram of a cigarette 10.

FIG. 2 is a block diagram illustrating the configuration of a network system according to the embodiment.

FIG. 3 is a conceptual diagram illustrating the configuration of a distributed ledger network 21.

FIG. 4 is a diagram illustrating the hardware configuration of a tobacco product transaction management server 100.

FIG. 5 is a diagram illustrating the data structure of a transaction history.

FIGS. 6(a) and 6(b) are diagrams illustrating the external configuration of a mobile terminal 200.

FIG. 7 is a function block diagram of the mobile terminal 200.

FIG. 8 is a sequence flow illustrating the operation of the mobile terminal 200 and the tobacco product transaction management server 100 in a case where a transaction history is registered.

FIG. 9 is a sequence flow illustrating the operation of the mobile terminal 200 and the tobacco product transaction management server 100 in the case where a transaction history is registered.

FIG. 10 is a configuration diagram of a container of the cigarette 10.

### DESCRIPTION OF EMBODIMENTS

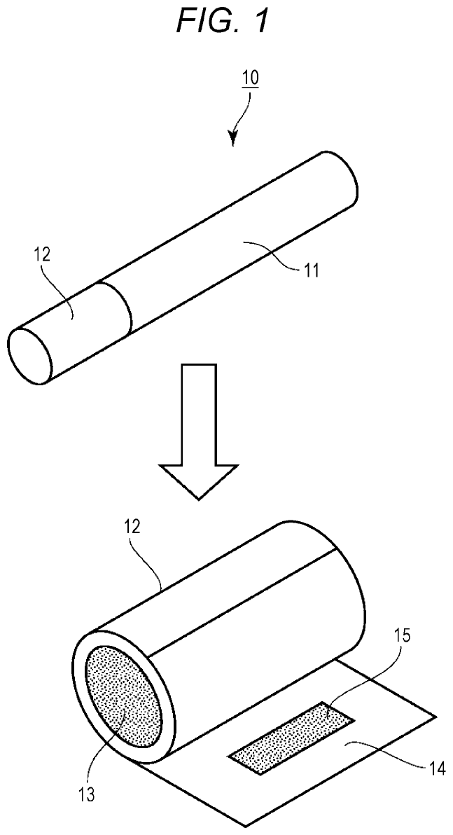

An embodiment of the present invention is described below. FIGS. 1 to 9 are diagrams illustrating the embodiment.

Firstly, the configuration of the embodiment is described.

FIG. 1 is a configuration diagram of a cigarette 10.

In the embodiment, the present invention is applied to a case where a history of one or more transactions that are conducted after the cigarette 10 is purchased (hereinafter simply referred to as a “transaction history”) is recorded in a distributed ledger, and the value of the cigarette 10 is calculated on the basis of the transaction history recorded in the distributed ledger.

As illustrated in FIG. 1, the cigarette 10 is configured, including tobacco 11 and a cigarette filter 12. The cigarette filter 12 is configured, including cigarette filter fiber 13 and cigarette filter paper 14. A mating surface between the cigarette filter paper 14 and the cigarette filter fiber 13 is provided with an IC tag 15 where identification information for identifying the cigarette 10 is recorded. For example, a string of integers or a character string, which is sufficiently long to avoid overlaps, considering the number of production cases of the cigarettes 10, may be used as the identification information. Moreover, encryption may be performed to prevent intentional tampering. Moreover, the identification information is recorded in a part of the cigarette 10 housed in a container of the cigarette 10 in the course of the production of the cigarette 10.

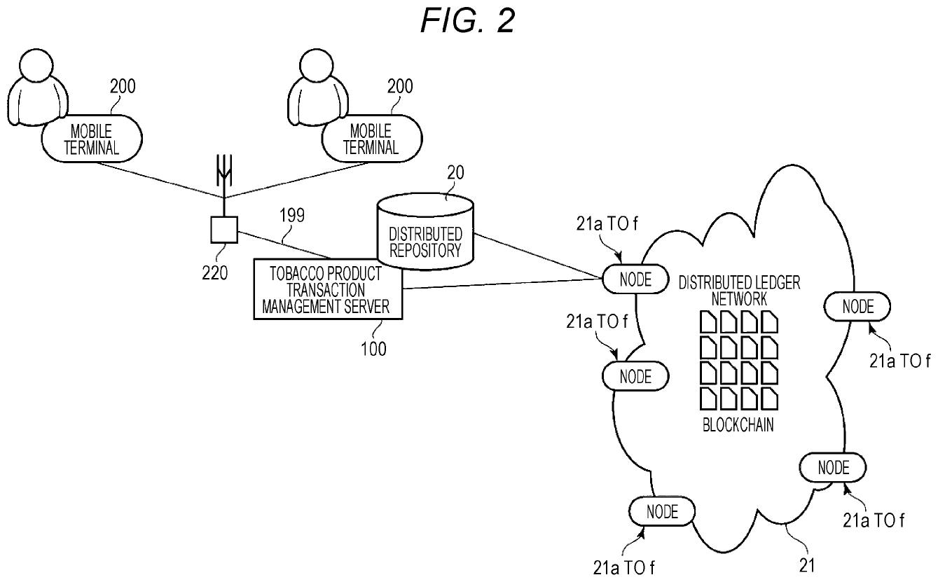

FIG. 2 is a block diagram illustrating the configuration of a network system according to the embodiment.

As illustrated in FIG. 2, an internet 199 is connected to a tobacco product transaction management server 100 that manages transactions of the cigarettes 10, and a base station 220 that relays communication between a mobile terminal 200 and the internet 199.

The base station 220 is connected wirelessly to a plurality of the mobile terminals 200. The mobile terminal 200 is a terminal used by a user, and is, for example, a smartphone. The base station 220 functions as a terminal on the internet 199 instead of the mobile terminal 200 when the mobile terminal 200 is connected to the internet 199. The base station 220 transmits data received from the mobile terminal 200 via the base station 220 to a target terminal via the internet 199. Furthermore, the base station 220 transmits data of a target terminal on the internet 199 to the mobile terminal 200 via the base station 220.

The tobacco product transaction management server 100 is configured, including a distributed repository 20 being a distributed storage system. The tobacco product transaction management server 100 is connected to a distributed ledger network 21 that records a transaction history. The transaction history is shared with other servers and the like by the distributed repository 20 tied to the distributed ledger network 21.

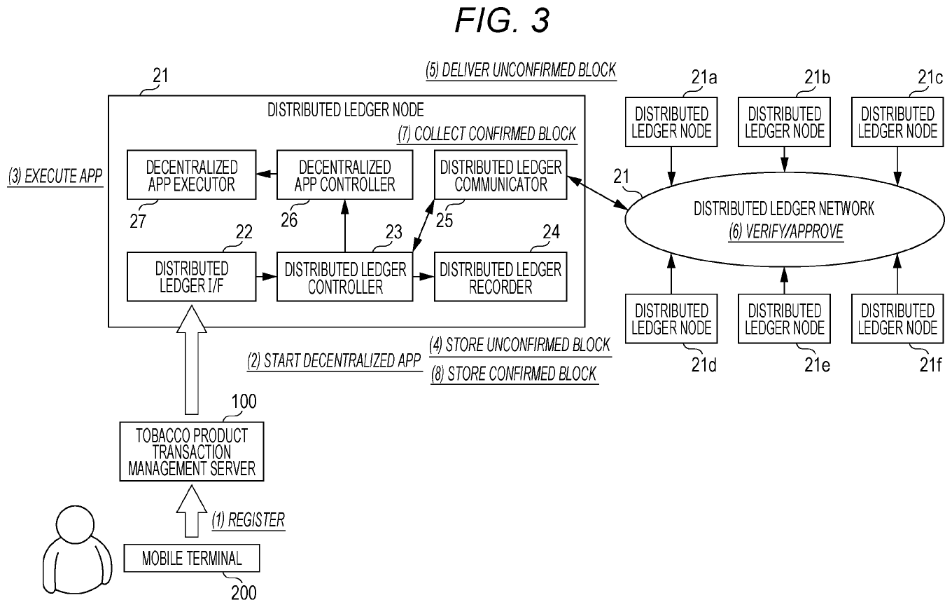

Next, the mechanism of the distributed ledger network 21 is described. FIG. 3 is a conceptual diagram illustrating the configuration of the distributed ledger network 21.

As illustrated in FIG. 3, the distributed ledger network 21 is implemented by a decentralized application (hereinafter simply referred to as a “decentralized app”). A transaction history is recorded in a blockchain on the distributed ledger network 21. The distributed ledger network 21 can provide a plurality of kinds of ledgers of a single or a plurality of distributed ledger networks, and a decentralized app as a service using a single decentralized app and a distributed ledger, or a service including a plurality of decentralized apps and a distributed ledger, through an API (Application Programming Interface).

The configuration of the system is described in detail. A transaction history is recorded by distributed ledger nodes 21x (21a to 21f), and a decentralized app that runs on the tobacco product transaction management server 100.

The distributed ledger nodes 21x (21a to 21f) are realized by many information processing terminals such as servers, personal computers, or smartphones dispersedly located on a communication network such as the internet 199 or a P2P network. The decentralized app that runs on each information processing terminal constructs function modules virtually on a CPU (Central Processing Unit) to record a transaction history. Specifically, CPUs of the distributed ledger nodes 21a to 21f are configured, including a distributed ledger interface 22, a distributed ledger controller 23, a distributer ledger recorder 24, a distributed ledger communicator 25, a decentralized app controller 26, and a decentralized app executor 27.

The distributed ledger interface 22 is a communication interface that receives a control signal ((2) in FIG. 3) to start the decentralized app, the control signal being transmitted from the tobacco product transaction management server 100. The decentralized app controller 26 is a module that executes the decentralized app in accordance with control by the distributed ledger controller 23. The decentralized app executor 27 executes the decentralized app ((3) in FIG. 3).

The distributed ledger controller 23 is a transaction history recorder that records a transaction history through communication with the tobacco product transaction management server 100 conducted via the distributed ledger interface 22. The distributed ledger controller 23 is a module that controls the execution of the decentralized app and processing in the distributed ledger recorder 24 in accordance with receipt in the distributed ledger interface 22. The distributed ledger recorder 24 is storage means for recording a transaction history. Specifically, the distributed ledger recorder 24 is a module that stores an unconfirmed block ((4) in FIG. 3) related to control of the distributed ledger by the distributed ledger controller 23, and a confirmed block ((8) in FIG. 3) being a result.

The distributed ledger communicator 25 is a data communication interface that transmits and receives data to and from the other distributed ledger nodes 21a to 21f on the distributed ledger network 21. The distributed ledger communicator 25 delivers unconfirmed blocks related to transaction histories to the other distributed ledger nodes 21a to 21f ((5) in FIG. 3), and collects confirmed blocks processed by the other distributed ledger nodes 21a to 21f ((8) in FIG. 3). The confirmed blocks collected and the unconfirmed blocks to be delivered to the other are given to and received by the distributed ledger controller 23.

Next, the configuration of the tobacco product transaction management server 100 is described.

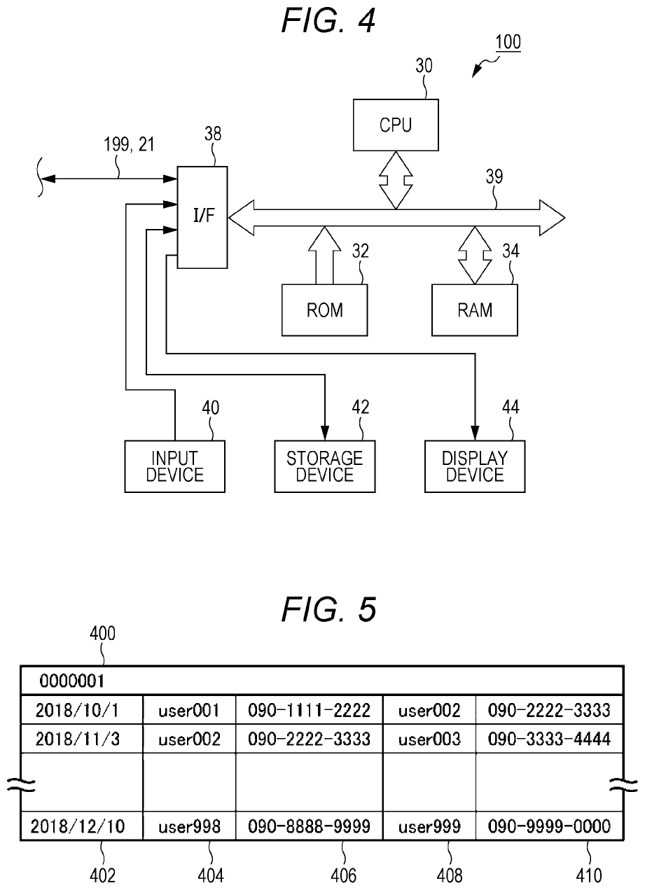

FIG. 4 is a diagram illustrating the hardware configuration of the tobacco product transaction management server 100.

As illustrated in FIG. 4, the tobacco product transaction management server 100 is configured of a CPU 30 that perform computations and control on the basis of a control program, a ROM (Read Only Memory) 32 that previously stores, for example, the control program of the CPU 30 in a predetermined area, a RAM (Random Access Memory) 34 for storing data read from, for example, the ROM 32, and a computation result required in the course of a computation of the CPU 30, and an I/F (InterFace) 38 through which the input and output of data is transmitted to an external apparatus. They are connected to each other via a bus 39 being a signal line for transferring data in such a manner as to be able to give and receive data to and from each other.

The I/F 38 is connected to an input device 40 as a human interface that can take data input and includes a keyboard and a mouse, a storage device 42 that stores, for example, data and tables as files, a display device 44 that displays a screen on the basis of an image signal, and a signal line for connecting to the internet 199 and the distributed ledger network 21, as external devices.

Next, the data structure of a transaction history managed by the tobacco product transaction management server 100 is described.

FIG. 5 is a diagram illustrating the data structure of a transaction history.

As illustrated in FIG. 5, a transaction history includes identification information of the cigarette 10 as meta-information 400. Moreover, a transaction history includes one record for each transaction. Each record is configured, including a field 402, a field 404, a field 406, a field 408, and a field 410. The field 402 is a field for registering the date and time when a transaction of the cigarette 10 was made. The field 404 is a field for registering a user ID for identifying a user who transferred the cigarette 10 (hereinafter referred to as a “transferor user”) in the transaction. The field 406 is a field for registering contact information of the mobile terminal 200 of the transferor user. The field 408 is a field for registering a user ID for identifying a user to whom the cigarette 10 was transferred (hereinafter referred to as a “transferee user”) in the transaction. The field 410 is a field for registering contact information of the mobile terminal 200 of the transferee user.

Next, the configuration of the mobile terminal 200 is described.

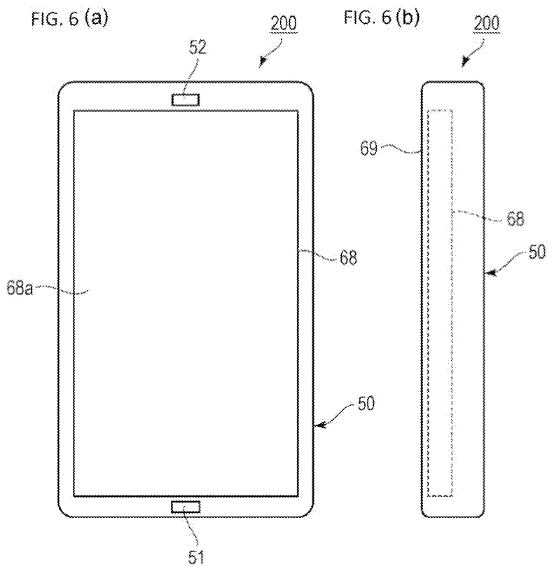

FIGS. 6(a) and 6(b) are diagrams illustrating the external configuration of the mobile terminal 200. FIG. 6(a) is a front view of the mobile terminal 200. FIG. 6(b) is a side view of the mobile terminal 200.

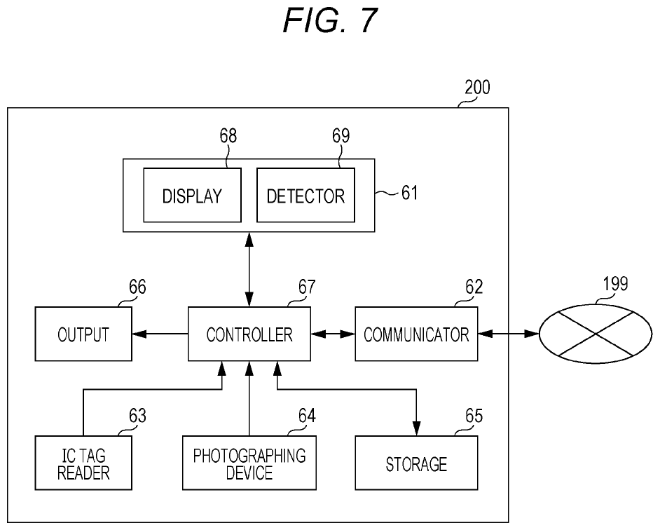

FIG. 7 is a function block diagram of the mobile terminal 200.

As illustrated in FIGS. 6(a) and 6(b), the mobile terminal 200 is configured, including a cabinet 50 having a front and a back side. The front side of the cabinet 50 is provided with a touchscreen 61. The touchscreen 61 is configured, including a display 68 that displays an image, and a detector 69 placed on the display 68.

The display 68 is configured, including a liquid crystal panel, and a panel backlight that illuminates the liquid crystal panel. The liquid crystal panel includes a display surface 68a for displaying an image. The display surface 68a appears outside. The detector 69 is provided on the display surface 68a. An organic EL (Electro Luminescence) panel, or other display devices can also be used instead of the liquid crystal panel.

The detector 69 includes a touch sensor, and is formed into a transparent sheet shape. The display surface 68a can be seen through the detector 69. The detector 69 is configured, including first and second transparent electrodes provided in a matrix, and a cover. The detector 69 detects a change in the capacitance between the first and second transparent electrodes. Consequently, the detector 69 detects the location of a touch by a user on the display surface 68a (hereinafter referred to as an “input location”), and outputs, to a controller 67, a location signal in accordance with the input location. Not limited to a capacitive detector but also, for example, an ultrasonic, pressure-sensitive, resistive, or optical detector can also be used as the detector 69.

The front side of the cabinet 50 is provided with a microphone 51 and a speaker 52. The user captures sound from the speaker 52 with the ears and emits sound to the microphone 51, which enables communication.

The back side of the cabinet 50 is provided with a lens window (not illustrated) of a photographing device 64. An image of a subject is captured into the photographing device 64 through the lens window.

As illustrated in FIG. 7, the mobile terminal 200 is configured, including the touchscreen 61, a communicator 62, an IC tag reader 63, the photographing device 64, a storage 65, an output 66, and the controller 67.

The display 68 displays, for example, a GUI (Graphical User Interface) used for user operation in accordance with the control of the controller 67. The detector 69 outputs coordinate information representing an input location to the controller 67. If text is inputted, a keyboard image (GUI) is displayed on the display 68 with, for example, a tap on a text box. A character placed in the keyboard image can be inputted by, for example, being tapped. In addition, it is also possible to input text by performing a character recognition process on the basis of a photograph image taken by the photographing device 64, or by performing a speech recognition process on the basis of sound inputted into the microphone 51.

The communicator 62 performs data communications in compliance with a wireless communication standard used in a mobile telephone. The communicator 62 requests, for example, a server to transmit information via a network such as the Internet. The communicator 62 then receives information transmitted from, for example, the server, and outputs the information to the controller 67.

The IC tag reader 63 can read identification information from the IC tag 15 in a non-contact manner.

The photographing device 64 is configured, including an imaging device such as a CCD (Charge Coupled Device) sensor or a CMOS (Complementary Metal Oxide Semiconductor) sensor. The photographing device 64 takes a photograph in accordance with a user's shutter operation. When the photographing device 64 takes a photograph, then the controller 67 stores the taken photograph image in the storage 65.

The storage 65 is configured, including a nonvolatile semiconductor memory (for example, EEPROM (Electronically Erasable and Programmable Read Only Memory)). The storage 65 stores a program (application software) for the controller 67 to execute, and a photograph image taken by the photographing device 64.

The controller 67 is configured of, for example, a CPU, a ROM, and a RAM, which are connected by a bus.

Next, the operation of the embodiment is described.

Firstly, a case where a transaction history is registered is described.

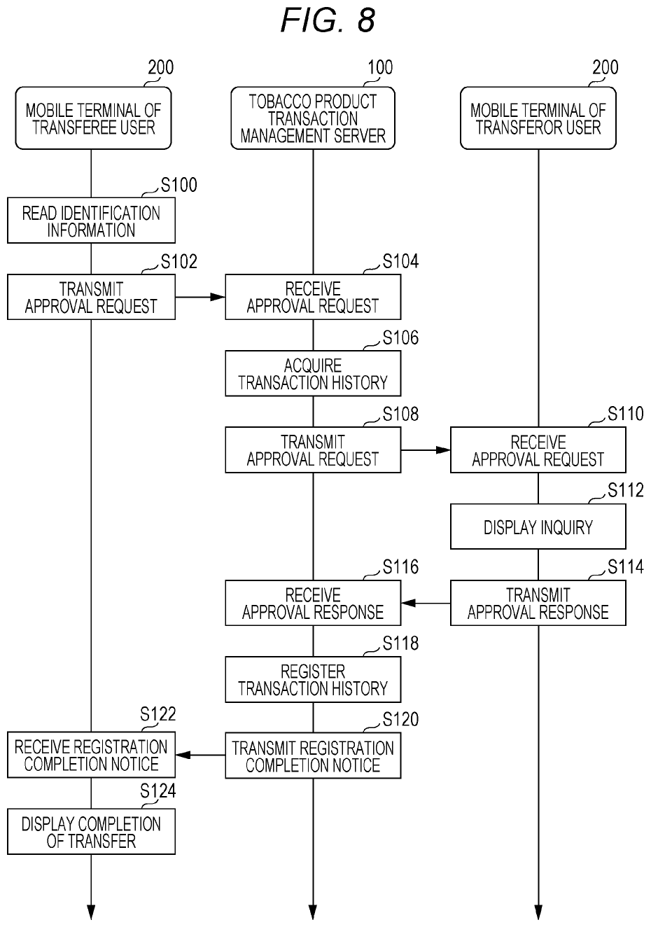

FIG. 8 is a sequence flow illustrating the operation of the mobile terminal 200 and the tobacco product transaction management server 100 in a case where a transaction history is registered.

The CPU 30 is, for example, an MPU (Micro-Processing Unit), and starts a predetermined program stored in a predetermined area of the ROM 32. The tobacco product transaction management server 100 executes the following process in accordance with the program. Moreover, an application that, for example, registers a transaction history by communication with the tobacco product transaction management server 100 is installed in the mobile terminal 200. When the application is started, a predetermined application program stored in a predetermined area of the ROM starts, and the following process is executed in accordance with the application program.

If the cigarette 10 is transferred from another user, the transferee user reads the identification information from the transferred cigarette 10 with his/her own mobile terminal 200. In the mobile terminal 200 of the transferee user, the IC tag reader 63 reads the identification information from the cigarette 10 (S100), and an approval request is transmitted to the tobacco product transaction management server 100 together with the read identification information, and the user ID and contact information of the transferee user (S102).

In the tobacco product transaction management server 100, when the approval request is received together with the identification information, and the user ID and contact information (S104), a transaction history including the received identification information is acquired from the distributed repository 20 (S106). An approval request is transmitted by, for example, SMS (Short Message Service) to the mobile terminal 200 of the transferor user, taking the latest registered transferee user as the transferor user, on the basis of the acquired transaction history (S108).

In the mobile terminal 200 of the transferor user, when the approval request is received (S110), an inquiry about whether or not to approve the transfer of the cigarette 10 is displayed on the touchscreen 61 (S112). When the transferor user inputs a response to the effect of approval on the touchscreen 61, an approval response is transmitted to the tobacco product transaction management server 100 together with the user ID and contact information of the transferor user (S114). When the transferor user inputs a response to the effect of disapproval on the touchscreen 61, a disapproval response is transmitted to the tobacco product transaction management server 100.

In the tobacco product transaction management server 100, when the approval response is received together with the user ID and contact information (S116), a record including (1) the current year, month, and day, (2) the user ID and contact information of the transferor user received in step S116, and (3) the user ID and contact information of the transferee user received in step S104 is added to the transaction history acquired in step S106. The transaction history to which the record has been added is registered in the distributed ledger recorder 24 via the distributed ledger network 21 (S118). When the registration of the transaction history is completed, a registration completion notice is transmitted by, for example, SMS to the mobile terminal 200 of the transferee user on the basis of the contact information of the transferee user received in step S104 (S120).

In the mobile terminal 200 of the transferee user, when the registration completion notice is received (S122), the information that the transfer of the cigarette 10 has been completed is displayed on the touchscreen 61 (S124).

Next, a case where the value of the cigarette 10 is displayed is described.

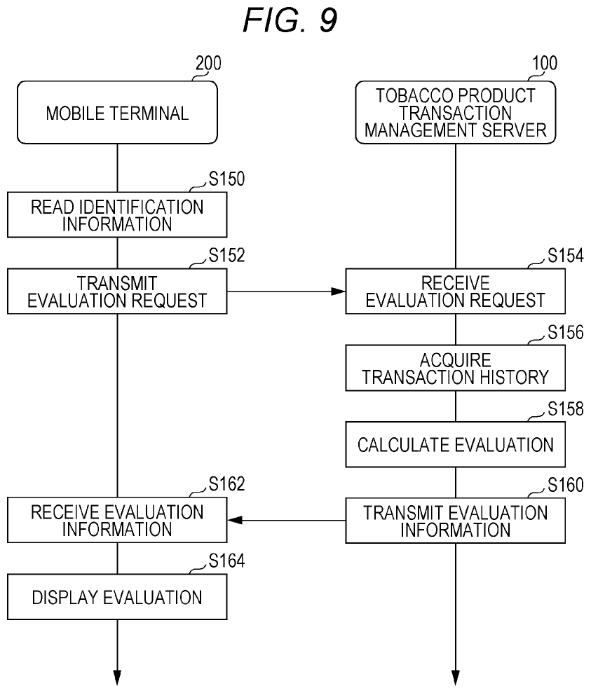

FIG. 9 is a sequence flow illustrating the operation of the mobile terminal 200 and the tobacco product transaction management server 100 in the case where a transaction history is registered.

If a user wants to know the value of the cigarette 10, the user reads the identification information from the cigarette 10 owned by the user with his/her own mobile terminal 200. In the mobile terminal 200, the identification information is read from the cigarette 10 with the IC tag reader 63 (S150), an evaluation request is transmitted to the tobacco product transaction management server 100 together with the read identification information and the user ID and contact information of the user (S152).

In the tobacco product transaction management server 100, when the evaluation request is received together with the identification information and the user ID and contact information (S154), a transaction history including the received identification information is acquired from the distributed repository 20 (S156). The value of the cigarette 10 is calculated on the basis of the acquired transaction history (S158). For example, the degree of name recognition of a user (for example, the number of hits or ranking information on a search engine) is calculated on the internet 199 for each user involved in the transaction. The value of the cigarette 10 can be calculated on the basis of the calculated degree of name recognition. Moreover, the value of the cigarette 10 can also be calculated on the basis of, for example, the number of users involved in the transaction. Moreover, a setting where the value increases after the user passes away, or a setting where the value fluctuates on a daily basis can also be made. Moreover, an evaluation can also be calculated on the basis of, for example, the number of celebrities through whom the transaction has been conducted. In addition, in terms of a value calculation method, a publicly known technology, or an arbitrary algorithm can be adopted.

In the tobacco product transaction management server 100, when the value of the cigarette 10 is calculated, value information representing the calculated value is transmitted to the mobile terminal 200 (S160).

In the mobile terminal 200, when the value information is received (S162), the value of the cigarette 10 is displayed on the touchscreen 61 on the basis of the received value information (S164).

Next, the effects of the embodiment are described.

In the embodiment, the tobacco product transaction management server 100 receives the identification information of the cigarette 10 and the user IDs of the transactors, and registers, in the distributed ledger recorder 24, a transaction history related to the transferor user and transferee user of the cigarette 10 and associated with the received identification information, the transaction history including the received identification information and user IDs.

Consequently, it is possible to grasp a transaction history related to a transferor user and transferee user of the cigarette 10. Moreover, registration in the distributed ledger allows reducing a possibility of, for example, tampering with the transaction history.

Furthermore, in the embodiment, the tobacco product transaction management server 100 receives identification information, acquires a transaction history associated with the received identification information from the distributed ledger recorder 24, and calculates the value of the cigarette 10 on the basis of the acquired transaction history.

Consequently, it is possible to grasp the value of the cigarette 10 on the basis of a transaction history.

Furthermore, in the embodiment, the identification information is recorded in a part of the cigarette 10 housed in a container of the cigarette 10.

Consequently, it is possible to selectively or partially conduct, for example, a sample survey.

In the embodiment, the distributed ledger recorder 24 corresponds to the storage means of the first, second, fifth, or eighth aspect of the present invention. The mobile terminal 200 corresponds to the transactor terminal of the eleventh aspect of the present invention, the transferor terminal of the twelfth, fourteenth, or fifteenth aspect of the present invention, or the transferee terminal of the twelfth or sixteenth aspect of the present invention. Step S102 corresponds to the identification information etc. output means of the eleventh, twelfth, or sixteenth aspect of the present invention. Moreover, step S104 corresponds to the identification information etc. acquisition means of the first, eleventh, twelfth, or sixteenth aspect of the present invention. Steps S112 and S114 correspond to the approval means of the twelfth or fifteenth aspect of the present invention. Step S118 corresponds to the transaction history registration means of the first or fourteenth aspect of the present invention.

Moreover, in the embodiment, step S154 corresponds to the identification information acquisition means of the second, fifth, eleventh, twelfth, or sixteenth aspect of the present invention. Step S156 corresponds to the transaction history acquisition means of the second or fifth aspect of the present invention. Step S158 corresponds to the value calculation means of the second or fifth aspect of the present invention. The user ID corresponds to the transactor information of the first, fifth, eleventh, twelfth, or sixteenth aspect of the present invention.

### Modification

In the above embodiment, the identification information is recorded in a part of the cigarette 10 housed in the container of the cigarette 10. However, the embodiment is not limited to this. The identification information may be recorded in the cigarette 10 selected by a predetermined rule (for example, randomly) from the cigarettes 10 to be shipped to the market.

Consequently, it is possible to selectively or partially conduct, for example, a sample survey.

Moreover, in the configurations of the above embodiment and modification thereof, the mobile terminal 200 of a transferee user reads the identification information from the cigarette 10. The mobile terminal 200 of a transferor user then approves in response to the approval request of the mobile terminal 200 of the transferee user. However, the embodiment and the modification are not limited to this. It can also be configured in such a manner that the mobile terminal 200 of a transferor user approves, and then the mobile terminal 200 of a transferee user reads the identification information from the approved cigarette 10.

Moreover, in the configurations of the above embodiment and modification thereof, the transaction history is registered if approval is gained from the mobile terminal 200 of a transferor user. The embodiment and the modification are not limited to this. It can also be configured in such a manner that the mobile terminal 200 transmits the identification information and the user ID to the tobacco product transaction management server 100 if approval can be obtained from a transferor user.

Moreover, in the configurations of the above embodiment and modification thereof, the value of the cigarette 10 is calculated on the basis of the transaction history. The embodiment and the modification are not limited to this. The following configuration can be adopted.

A first configuration is as follows: The tobacco product transaction management server 100 receives identification information from the mobile terminal 200, and acquires a transaction history associated with the received identification information from the distributed ledger recorder 24. The tobacco product transaction management server 100 acquires owner information related to an owner of the cigarette 10, determines the appropriateness of the owner of the cigarette 10 on the basis of the acquired transaction history and owner information, and transmits determination result information representing a determination result to the mobile terminal 200. The mobile terminal 200 displays the appropriateness of the owner of the cigarette 10 on the touchscreen 61 on the basis of the received determination result information when receiving the determination result information.

Consequently, it is possible to grasp the appropriateness of the owner of the cigarette 10.

A second configuration is as follows: The tobacco product transaction management server 100 receives identification information from the mobile terminal 200, and acquires a transaction history associated with the received identification information from the distributed ledger recorder 24. The tobacco product transaction management server 100 identifies a disposer of the cigarette 10 on the basis of the acquired transaction history, and transmits disposer information related to the identified disposer to the mobile terminal 200. The mobile terminal 200 displays the disposer on the touchscreen 61 on the basis of the received disposer information when receiving the disposer information.

Consequently, it is possible to grasp a disposer of the cigarette 10 even if, for example, the cigarette 10 is transferred to another person after being purchased.

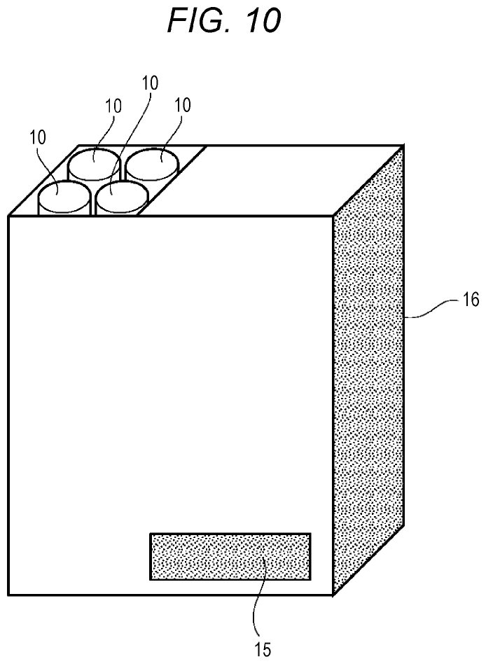

Moreover, in the above embodiment and modification thereof, the identification information is recorded in the cigarette 10. The embodiment and the modification are not limited to this. As illustrated in FIG. 10, the IC tag 15 may be provided to a container 16 of the cigarette 10, and the identification information may be recorded in the IC tag 15.

FIG. 10 is a configuration diagram of the container of the cigarette 10. Moreover, in the above embodiment and modification thereof, the identification information for identifying the cigarette 10 is adopted. The embodiment and the modification are not limited to this. It is also possible to adopt identification information for identifying the container 16 of the cigarette 10, or identification information for identifying a plurality of the cigarettes 10.

Moreover, in the above embodiment and modification thereof, the mobile terminal 200 is configured in such a manner as to transmit identification information and a user ID to the tobacco product transaction management server 100. The embodiment and the modification are not limited to this. The following configuration can be adopted.

A first configuration is as follows: The cigarette 10 or the container 16 thereof includes a sensor that reads the user ID from the mobile terminal 200 or other storage media. The sensor acquires the user ID of a transactor of the cigarette 10. The identification information of the cigarette 10 and the user ID acquired by the sensor are transmitted to the tobacco product transaction management server 100.

A second configuration is as follows: A transaction management apparatus accessible by a user is installed separately from the mobile terminal 200. The transaction management apparatus includes a sensor that reads the identification information and the user ID from the cigarette 10, the container 16 thereof, the mobile terminal 200, or other storage media. The sensor acquires the identification information of the cigarette 10 and the user ID of a transactor of the cigarette 10. The acquired identification information and user ID are transmitted to the tobacco product transaction management server 100. Here, the sensor may include two or more sensors having a first sensor that reads the identification information from the cigarette 10 or the container 16 and a second sensor that reads the user ID from the mobile terminal 200 or other storage media.

Moreover, in the configurations of the above embodiment and modification thereof, a transaction history is registered in the distributed ledger recorder 24. The embodiment and the modification are not limited to this. The following configuration can be adopted.

A first configuration is as follows: The cigarette 10 or the container 16 thereof includes storage means for storing a transaction history. The mobile terminal 200 writes a transaction history into the storage means with, for example, an IC tag writer. In this case, the transaction history, and the cigarette 10 or the container 16 are associated and recorded. Hence, the transaction history does not necessarily need to include identification information.

A second configuration is as follows: The cigarette 10 or the container 16 thereof includes storage means for storing a transaction history, and a sensor that reads the user ID from the mobile terminal 200 or other storage media. A transaction history including the user ID acquired by the sensor is registered in the storage means. In this case, the transaction history, and the cigarette 10 or the container 16 are associated and recorded. Hence, the transaction history does not necessarily need to include identification information.

Moreover, in the above embodiment and modification thereof, the distributed ledger recorder 24 is provided on the distributed ledger network 21. The embodiment and the modification are not limited to this. The storage means for storing a transaction history can be provided to the cigarette 10 or the container 16 thereof. Furthermore, the storage means of each cigarette 10 or container 16 can be configured as a distributed ledger recorder. In this case, it can also be configured in such a manner that when coming closer to each other, the cigarettes 10 or containers 16 each allow the other to record its own transaction history by wireless communication. Hence, as the number of transactions of the cigarette 10 is increased, more transaction histories of other cigarettes 10 that came closer in the course of the transactions can be possessed. Hence, it is possible to realize the function of the distributed ledger with a relatively simple configuration. Moreover, it is possible to, if the cigarette 10 or the container 16 is obtained, grasp not only the transaction history of the cigarette 10 but also the transaction histories of other cigarettes 10 that came closer in the course of the transaction. It is simply required to exchange transaction histories by registering the transaction history of one cigarette 10 or container 16 in the storage means of the other cigarette 10 or container 16. Transaction histories are not necessarily required to be mutually registered.

Moreover, in the above embodiment and modification thereof, a transaction history is configured, including the user ID and contact information of a transferor user, and the user ID and contact information of a transferee user. The embodiment and the modification are not limited to this. It is simply required to configure a transaction history including the user ID of a transferor or transferee user. If the configuration where a transaction history does not include contact information is adopted, it is simply required to manage the contact information in another database.

Moreover, in the above embodiment and modification thereof, a user ID is adopted as the information for identifying a user. The embodiment and the modification are not limited to this. It is also possible to adopt an individual number or other kinds of personal information.

Moreover, in the configurations of the above embodiment and modification thereof, the tobacco product transaction management server 100 is provided. The embodiment and the modification are not limited to this. It can also be configured in such a manner that the functions of the tobacco product transaction management server 100 are provided to the mobile terminal 200, or the cigarette 10 or the container 16 thereof, and the tobacco product transaction management server 100 is not provided. Moreover, it can also be configured in such a manner that the functions of the tobacco product transaction management server 100 and the mobile terminal 200 are provided to the cigarette 10 or the container 16, and the tobacco product transaction management server 100 and the mobile terminal 200 are not provided.

Moreover, in the configurations of the above embodiment and modification thereof, the mobile terminal 200 is provided. The embodiment and the modification are not limited to this. It can also be configured in such a manner that the functions of the mobile terminal 200 are provided to the tobacco product transaction management server 100, or the cigarette 10 or the container 16 thereof, and the mobile terminal 200 is not provided.

Moreover, in the above embodiment and modification thereof, the network system is realized. The embodiment and the modification are not limited to this. It is also possible to realize a single apparatus or an application.

Moreover, in the above embodiment and modification thereof, the application to the network system including the internet 199 is described. The embodiment and the modification are not limited to this. For example, application to what is called an intranet that carries out communication by the same system as the internet 199 is also possible. Naturally, not only application to a network that carries out communication by the same system as the internet 199 but also application to a network of an arbitrary communication system is also possible.

Moreover, in the above embodiment and modification thereof, a description is given of the case where the program previously stored in the ROM is executed upon execution of both processes illustrated in the sequence flows in FIGS. 8 and 9. The embodiment and the modification are not limited to this. A program presenting these procedures, which has been read into the RAM from a storage medium where the program is stored, may be executed.

Here, the storage medium is a semiconductor storage medium such as a RAM or ROM, a magnetic storage type storage medium such as an FD or HD, a storage medium of an optical reading system such as a CD, CDV, LD, or DVD, or a storage medium of a magnetic storage type/optical reading system such as an MO. The storage medium is simply required to be a computer-readable storage medium irrespective of a reading method such as electronic, magnetic, or optical, and includes every storage medium.

Moreover, in the configurations of the above embodiment and modification thereof, the present invention is applied to the cigarette 10. The embodiment and the modification are not limited to this. Application to other cases within the scope that does not depart from the gist of the present invention is also possible. For example, application to a cigar, a pipe, a Japanese pipe, a hookah, a smokeless tobacco product, a heat-not-burn tobacco product, an electronic cigarette, or other tobacco products is also possible. Moreover, application to marijuana, and other articles or goods is also possible.

### DESCRIPTION OF REFERENCE SIGNS

10 Cigarette
11 Tobacco
12 Cigarette filter
13 Cigarette filter fiber
14 Cigarette filter paper
15 IC tag
16 Container
20 Distributed repository
21 Distributed ledger network
21x, 21a to 21f Distributed ledger node
22 Distributed ledger interface
23 Distributed ledger controller
24 Distributed ledger recorder
25 Distributed ledger communicator
26 Decentralized app controller
27 Decentralized app executor
100 Tobacco product transaction management server
30 CPU
32 ROM
34 RAM
38 I/F
39 Bus
40 Input device
42 Storage device
44 Display device
200 Mobile terminal
50 Cabinet
51 Microphone
52 Speaker
61 Touchscreen
62 Communicator
63 IC tag reader
64 Photographing device
65 Storage
66 Output
67 Controller
68 Display
68a Display surface
69 Detector
199 Internet
220 Base station
400 Meta-information
402 to 410 Field

1-36. (canceled)

37. An article transaction management system comprising:
identification information acquisition means for acquiring identification information;
transaction history acquisition means for acquiring a transaction history associated with the identification information acquired by the identification information acquisition means from storage means for storing the transaction history related to a transaction of an article or good and associated with the identification information recorded in the article or good, or a container thereof, the transaction history including the identification information and transactor information related to a transactor of the article;
value calculation means for calculating the value of the article or good on the basis of the transaction history acquired by the transaction history acquisition means; and
a plurality of nodes of a distributed ledger, wherein:
each node corresponds to a different computing device,
the storage means is the distributed ledger, and
at least one of the plurality of nodes comprises a distributed ledger controller that adds a new record to the stored transaction history based on transactions using the transaction history.

38. The article transaction management system according to claim 37, wherein
the transaction history acquisition means acquires a transaction history associated with the identification information acquired by the identification information acquisition means from storage means for storing the transaction history related to a transferor and transferee of a tobacco product and associated with the identification information recorded in the tobacco product or a container thereof, the transaction history including the identification information and transactor information related to a transactor of the tobacco product, and
the value calculation means calculates the value of the tobacco product on the basis of the transaction history acquired by the transaction history acquisition means.

39. The article transaction management system according to claim 38, wherein the value calculation means calculates the value of the tobacco product on the basis of the degree of name recognition of the transactor involved in a transaction of the tobacco product.

40. The article transaction management system according to claim 38, wherein the value calculation means calculates the value of the tobacco product on the basis of the number of transactors involved in a transaction of the tobacco product.

41. (canceled)

42. The article transaction management system according to claim 38, comprising disposer identifying means for identifying a disposer of the tobacco product on the basis of the transaction history acquired by the transaction history acquisition means.

43. The article transaction management system according to claim 38, comprising:
identification information etc. acquisition means for acquiring the identification information recorded in the tobacco product or the container thereof, and the transactor information related to the transactor of the tobacco product; and
transaction history registration means for registering, in the storage means, a transaction history related to a transferor and transferee of the tobacco product and associated with the identification information acquired by the identification information etc. acquisition means, the transaction history including the identification information and the transactor information acquired by the identification information etc. acquisition means.

44. The article transaction management system according to claim 43, wherein
a transferor terminal used by the transferor and a transferee terminal used by the transferee are communicably connected to each other,
the transferor terminal includes approval means for approving transfer of the tobacco product,
the transferee terminal includes:
the identification information acquisition means for acquiring the identification information from the tobacco product or the container thereof; and
identification information etc. output means for outputting the identification information acquired by the identification information acquisition means and the transactor information where the transferee is the transactor in such a manner as to be able to be acquired by the identification information etc. acquisition means, and
the transaction history is registered upon approval being gained from the transferor terminal.

45. (canceled)

46. The article transaction management system according to claim 38, wherein the identification information is recorded in a part of the tobacco product housed in the container.

47. The article transaction management system according to claim 38, wherein the identification information is recorded in a tobacco product selected by a predetermined rule from tobacco products to be shipped to the market.

48. A communication terminal communicably connected to an article transaction management terminal including:
identification information receiving means for receiving identification information;
transaction history acquisition means for acquiring a transaction history associated with the identification information received by the identification information receiving means from storage means for storing the transaction history related to a transaction of an article or good and associated with the identification information recorded in the article or good, or a container thereof, the transaction history including the identification information and transactor information related to a transactor of the article;
value calculation means for calculating the value of the article or good on the basis of the transaction history acquired by the transaction history acquisition means; and
value information transmission means for transmitting value information representing the value calculated by the value calculation means, the communication terminal comprising:
identification information transmission means for transmitting the identification information to the article transaction management terminal;
value information receiving means for receiving the value information from the article transaction management terminal; and
value output means for outputting the value of the article or good on the basis of the value information received by the value information receiving means,
wherein the communication terminal communicates with a plurality of nodes of a distributed ledger, wherein:
each node corresponds to a different computing device,
the storage means is the distributed ledger, and
at least one of the plurality of nodes comprises a distributed ledger controller that adds a new record to the stored transaction history based on transactions using the transaction history.

49. The communication terminal according to claim 48, wherein
the transaction history acquisition means acquires a transaction history associated with the identification information received by the identification information receiving means from storage means for storing the transaction history related to a transferor and transferee of a tobacco product and associated with the identification information recorded in the tobacco product or a container thereof, the transaction history including the identification information and transactor information related to a transactor of the tobacco product,
the value calculation means calculates the value of the tobacco product on the basis of the transaction history acquired by the transaction history acquisition means, and
the value output means outputs the value of the tobacco product on the basis of the value information received by the value information receiving means.

50. The communication terminal according to claim 49, comprising identification information acquisition means for acquiring the identification information from the tobacco product or the container thereof, wherein the identification information transmission means transmits the identification information acquired by the identification information acquisition means to the tobacco product transaction management terminal.
